(19) United States
(12) Patent Application Publication
(10) Pub. No.: US 2024/0241964 A1
(43) Pub. Date: Jul. 18, 2024

(54) DEPICTING A RELATIVE EXTENT OF VULNERABILITY ASSOCIATED WITH A WEB APPLICATION DEPLOYED ON A DOMAIN

(71) Applicant: International Business Machines Corporation, Armonk, NY (US)

(72) Inventors: Tamojit Das, Stamford, CT (US); Paritosh Ranjan, Kolkata (IN)

(21) Appl. No.: 18/098,600

(22) Filed: Jan. 18, 2023

(51) Int. Cl. G06F 21/57

(52) U.S. Cl. CPC G06F 21/577; G06F 2221/033

(57) ABSTRACT

A computer-implemented method, according to one embodiment, includes registering domains to be connected with a vulnerability service and using information obtained by an agent of the vulnerability service from infrastructure associated with web applications deployed on the domains to determine, for each domain, a relative extent of vulnerability associated with the web applications deployed on the domain. The method further includes outputting, for display on a user device, a depiction of the relative extent of vulnerability associated with the web applications deployed on a first of the domains in response to a determination that a user device is attempting to access the first domain. A computer program product, according to another embodiment, includes a computer readable storage medium having program instructions embodied therewith. The program instructions are readable and/or executable by a processing circuit to cause the processing circuit to perform the foregoing method.

### BACKGROUND

The present invention relates to vulnerability within an infrastructure, and more specifically, this invention relates to depicting a relative extent of vulnerability associated with a web application deployed on a domain.

Vulnerabilities pose a threat to all cyber related components in a network. For example, security vulnerabilities may include, e.g., a lack of data encryption, use of relatively outdated software, use of relatively outdated firmware, use of relatively outdated hardware, use of relatively outdated authentication checks, use of a component of a server that traffics untrustworthy websites, etc. According to a more specific example, the recent discovery of a log4j remote code execution vulnerability caused many administrators and corporations scrambling to determine whether their servers were impacted. Many servers remained vulnerable for days before anyone came to know about the vulnerability. In some cases, servers impacted by this log4j vulnerability have been used by server users who are completely unaware of the vulnerability present in the server.

One entity that is relatively most subject to losses from vulnerable servers susceptible to malicious exploit is a client and/or user of the server that has sensitive personal and/or financial data stored on the server and/or transacted through the server. Eventually, this data may be stolen, compromised, or lost in the event that a security breach incident occurs in the server due to the existence of vulnerable software components in the server. Accordingly, any vulnerability in a server jeopardizes a client's sensitive personal and/or financial data present in and/or transacted through the server.

### SUMMARY

A computer-implemented method, according to one embodiment, includes registering domains to be connected with a vulnerability service and using information obtained by an agent of the vulnerability service from infrastructure associated with web applications deployed on the domains to determine, for each domain, a relative extent of vulnerability associated with the web applications deployed on the domain. The method further includes outputting, for display on a user device, a depiction of the relative extent of vulnerability associated with the web applications deployed on a first of the domains in response to a determination that a user device is attempting to access the first domain.

A computer program product, according to another embodiment, includes a computer readable storage medium having program instructions embodied therewith. The program instructions are readable and/or executable by a processing circuit to cause the processing circuit to perform the foregoing method.

A system, according to another embodiment, includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is a flowchart of a method, in accordance with one embodiment of the present invention.

FIG. 4 is a flowchart of a method, in accordance with one embodiment of the present invention.

FIG. 5 is a system, in accordance with one embodiment of the present invention.

FIGS. 6A-6C depict representations of a web browser, in accordance with several embodiments of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for depicting a relative extent of vulnerability associated with a web application deployed on a domain.

In one general embodiment, a computer-implemented method includes registering domains to be connected with a vulnerability service and using information obtained by an agent of the vulnerability service from infrastructure associated with web applications deployed on the domains to determine, for each domain, a relative extent of vulnerability associated with the web applications deployed on the domain. The method further includes outputting, for display on a user device, a depiction of the relative extent of vulnerability associated with the web applications deployed on a first of the domains in response to a determination that a user device is attempting to access the first domain.

In another general embodiment, a computer program product includes a computer readable storage medium having program instructions embodied therewith. The program instructions are readable and/or executable by a processing circuit to cause the processing circuit to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as vulnerability determination module of block 150 for depicting a relative extent of vulnerability associated with a web application deployed on a domain. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

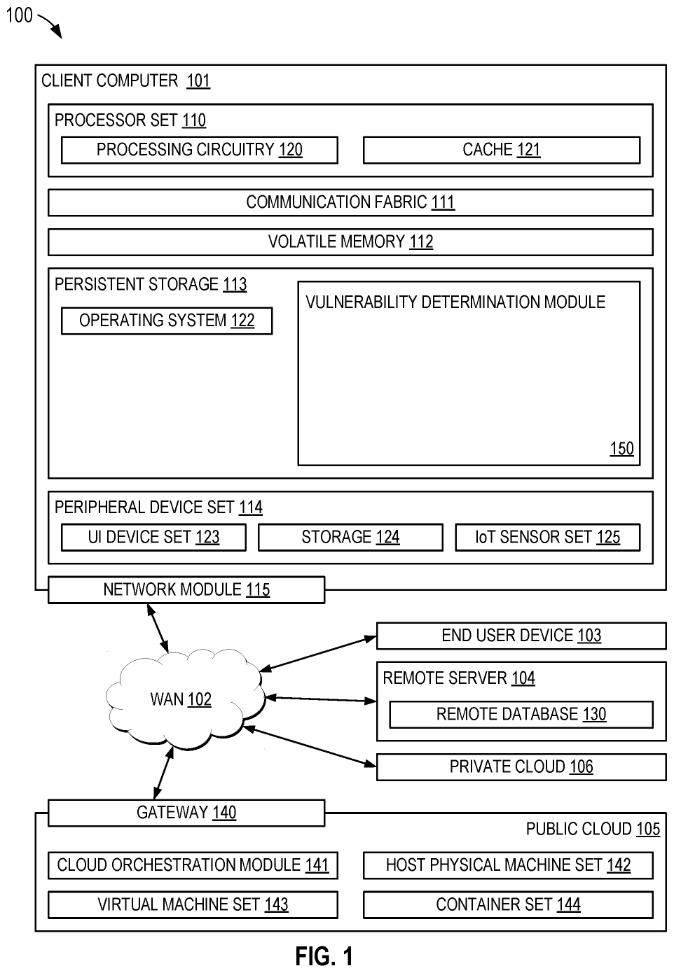

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system, according to various embodiments, may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

Vulnerabilities pose a threat to all cyber related components in a network. For example, security vulnerabilities may include, e.g., a lack of data encryption, use of relatively outdated software, use of relatively outdated firmware, use of relatively outdated hardware, use of relatively outdated authentication checks, use of a component of a server that traffics untrustworthy websites, etc. According to a more specific example, the recent discovery of a log 4j remote code execution vulnerability caused many administrators and corporations scrambling to determine whether their servers were impacted. Many servers remained vulnerable for days before anyone came to know about the vulnerability. In some cases, servers impacted by this log 4j vulnerability have been used by server users who are completely unaware of the vulnerability present in the server.

One entity that is relatively most subject to losses from vulnerable servers susceptible to malicious exploit is a client and/or user of the server that has sensitive personal and/or financial data stored on the server and/or transacted through the server. Eventually, this data may be stolen, compromised, or lost in the event that a security breach incident occurs in the server due to the existence of vulnerable software components in the server. Accordingly, any vulnerability in a server jeopardizes a client's sensitive personal and/or financial data present in and/or transacted through the server.

Currently, there is no way for a client and/or user to confirm that there is no vulnerability present in a server they are interacting with. It should be noted that conventional certificates being presented by a server to a user confirming that the server is in fact who the server is claiming to be does not ensure that a vulnerability is not present in the server. For example, such certificates to not address the problem of knowing whether vulnerable components exist in the server. Furthermore, conventional vulnerability measures fail to make a user aware of the vulnerability status of an application behind the domain the user is interacting with. Accordingly, currently, there is no way for end users to know whether they are interacting with an application which has vulnerabilities that can endanger the user's data being transmitted through and/or stored in the application, which is behind the domain.

Ideally, a client should only trust servers/portals which confirm that there is no vulnerability present in the server. This confirms that the client's and/or user's data and the transactions occurring in or through that server will remain secure. However, no conventional mechanism exists which can confirm the absence or presence of vulnerabilities in a server to a client.

In sharp contrast to the deficiencies of the conventional offerings described above, various embodiments and approaches described herein solve this problem with techniques that enable even non-tech savvy users to understand whether a web application they are interacting with is capable of securing their information or causing such information to become vulnerable. These techniques thereby inform the user about the vulnerability status of the application the user is connecting to via the domain name. This empowers the user to make informed decisions on whether to stop interacting with and sharing data with a domain and/or application which is vulnerable, or to accept the risk and continue interacting with and sharing data with the domain and/or application which is vulnerable. These techniques furthermore enable organizations to secure and promote their business. For example, in some approaches, organizations may procure a cloud service configured to use the techniques described herein for web applications of the organization. This reduces security risks to the organization and demonstrates the security standards that the organization abides by. As a result, end user confidence to interact with the web applications is increased, and thus the business of the organizations is promoted. In some approaches, the continuous vulnerability compliance service enabled by these techniques can be offered by cloud providers as an offering which generates revenue for the cloud providers.

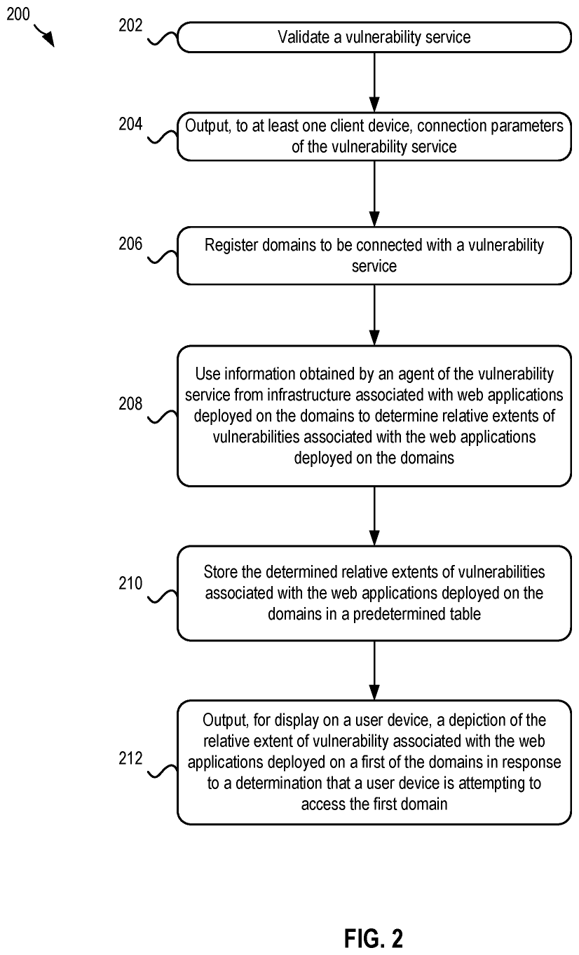

Now referring to FIG. 2, a flowchart of a method 200 is shown, according to one embodiment. The method 200 may be performed in accordance with the present invention in any of the environments depicted in FIGS. 1-6C, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a processing circuit, or some other device having one or more processors therein. The processor, e.g., processing circuit(s), chip(s), and/or module(s) implemented in hardware and/or software, and preferably having at least one hardware component may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 200 includes techniques that enable a real-time status of a vulnerability of any web portal to be shown, by showing vulnerability status depicting icons or information in web browsers and/or to clients based on a presence or an absence of vulnerable components in a web application deployment. Accordingly, these techniques serve as a continuous vulnerability service/authority which provide a real time status of the presence or absence of vulnerable components in a web application using one of the existing vulnerability detection systems in real time or of latest available vulnerability status with date.

As indicated above, in some approaches, techniques described herein may be offered as a service to web browsers and/or clients. Accordingly, method 200 may include providing predetermined web browsers and/or clients with pre-configured and/or stored connection parameters, e.g., URLs, credentials, etc., of one or more trusted and pre-validated continuous vulnerability services and/or authorities. One or more techniques for validating a service and/or authority that would become appreciated by one of ordinary skill in the art upon reading the descriptions herein may be used to cause one or more of such vulnerability services and/or authorities to be validated, e.g., see operation 202. Moreover, connection parameters of the vulnerability service may be output to one or more client devices, e.g., web browsers, client user devices, etc., in response to the vulnerability service being validated, e.g., see operation 204.

Operation 206 includes registering domains to be connected with one or more of the vulnerability services and/or authorities. It should be noted that although such domains may be registered with one or more vulnerability services and/or one or more authorities, various approaches described below are described with respect to one vulnerability service, which is not intended to limit the descriptions herein in any way. In some approaches, the domains being registered to be connected with the vulnerability service registers the domains for continuous monitoring for vulnerabilities associated with the domains.

In some approaches, the vulnerability service may use an agent to collect information that may be used to determine whether vulnerabilities are in fact associated with the web applications deployed on the domains. Such information may be received in some approaches, e.g., on a device performing method 200 from an agent of the vulnerability service, and thereafter used to determine whether vulnerabilities are in fact associated with the web applications deployed on the domains. For example, operation 208 includes using information obtained by an agent of the vulnerability service from monitoring performed on infrastructure associated with web applications deployed on the domains to determine, for each domain, a relative extent of vulnerability associated with the web applications deployed on the domain. Note that, depending on the approach, the web applications deployed on a first of the domains may be the same, or different, than the web applications deployed on a second of the domains. In some approaches, the infrastructure may be associated with web applications, where the association includes resources of the infrastructure being used by the web applications, e.g., as backend hardware, for running transactions through, for storing data on, using software of, etc.

The relative extents of vulnerabilities may, in some approaches, be determined based on results obtained based on the agent scanning at least some components of the infrastructure. In some approaches, method 200 includes causing, e.g., instructing, the agent to perform predetermined queries for scanning on one or more predetermined components of the infrastructure. The components of the infrastructure may, in some approaches, include, e.g., a virtual machine, a container, a code repository, physical hardware, software such as a software version being run, firmware, etc. Moreover, the results may, in some approaches, include and/or specify a version of software run by at least one server of the infrastructure such as where an outdated version may be known to be prone to vulnerabilities, hardware of the infrastructure, toolkits used by at least one server of the infrastructure, libraries of the infrastructure, code of a code repository of the infrastructure, dependencies among different components of the infrastructure, etc. Using the information obtained by the agent to determine the relative extents of vulnerabilities associated with the web applications deployed on the domains may, in some approaches, include comparing the results with predetermined tolerance thresholds. Accordingly, in some approaches, each of the results may include ranking values that are assigned based on a predetermined format. For example, a portion of a first server of the infrastructure running a relatively more recent version of software may be assigned a relatively higher ranking value and a portion of a second server running a relatively outdated version of software may be assigned a relatively lower ranking value. Comparison of the results with predetermined tolerance thresholds may, in one approach, include a relative extent of vulnerability associated with web applications deployed on a first domain being determined to be acceptable, e.g., within a tolerable predetermined range of vulnerability, in response to the results not exceeding the predetermined tolerance thresholds. In contrast, the relative extent of vulnerability associated with the web applications deployed on the first domain may be determined to be unacceptable, e.g., not fall within the tolerable predetermined range of vulnerability, in response to the results exceeding the predetermined tolerance thresholds. In some approaches, in which predetermined tolerance thresholds are used, the relative extents of vulnerability may include vulnerable and not vulnerable. In some other approaches, the relative extents of vulnerability may depend on a degree that the results are determined to exceed the predetermined threshold, results that are determined to exceed the predetermined threshold relatively more are determined to be very vulnerable, and results that are determined to exceed the predetermined threshold relatively less are determined to be somewhat vulnerable. This tiered relative extents of vulnerability may also be applied to results that do not exceed the predetermined threshold. For example, results that are determined to be relatively closer to exceeding the predetermined threshold are determined to be relatively somewhat not vulnerable, results that are determined to not be relatively closer to exceeding the predetermined threshold are determined to be relatively not at all vulnerable. The relative extents of vulnerability may additionally and/or alternatively be defined and based on what types of vulnerability and/or a number of vulnerabilities that are determined to be associated with the web applications deployed on the domains. This is because different types and/or a different number of vulnerabilities may be associated with different applications. Accordingly, in some approaches, the relative extents of vulnerability define at least one type of vulnerability and/or a number of vulnerabilities that are associated with the different applications.

According to some illustrative approaches, a service, e.g., hereafter referred to as an “artifact dependency publish service,” may be used, e.g., by the domains, to publish a list of artifacts used by the application hosted at their domain. For context, an “artifact” may be defined as a byproduct of software development that helps describe the architecture, design and/or function of software. Artifacts may include, e.g., databases, data models, printed documents, scripts, etc. The list of artifacts used may be pushed to be published, e.g., published by an artifact publish service via a REST, SOAP, gRPC application programming interface (API), etc., which may be exposed by the artifact publish service. In some approaches, the artifact list may be caused to be uploaded as a predetermined file, e.g., json, yml, etc., containing a unique identifier of each artifact. In some approaches, the unique identifiers of the artifacts may be provided by a predetermined directory, e.g., hereafter referred to as an “artifact vulnerability directory”.

Access to upload information for any domain is, in some preferred approaches, available only to the domain owner. The artifact dependency publish service authority may perform this verification beforehand, and only the domain owner may be granted access. One or more known techniques for identifying domain owners may be used. In some approaches, only these identified domain owners may be able to upload the artifact list e.g., to the artifact dependency publish service. In some approaches, the artifact list may be uploaded to an API of the artifact dependency publish services by the domain owner by calling the API via any API client manually. In another approach, the artifact list upload may be automated, e.g., performed by the artifact publish agent. In any case, in some approaches, the artifact list is preferably encrypted. For example, the artifact list may be encrypted using a public key, e.g., a public key of a site vulnerability service, which may be procured by the domain owner.

For context, these artifacts may, in some approaches, be used, e.g., by the agent which may also be referred to herein as an “artifact dependency publish agent”, to determine relative extents of vulnerabilities associated with the web applications deployed on the domains. In some approaches, the artifact dependency publish agent may be installed in a code repository, a virtual machine, a cluster, a container, etc., where the code is stored, or the application is deployed. The artifact dependency publish agent may need to be provided with the list of artifacts being used in the code repository or deployment by any known type of tool. The artifact list may be received by and/or sent to the artifact dependency publish agent, and thereafter may be encrypted by using the public key of the site vulnerability service which may be procured by the domain owner and may be configured in the artifact dependency publish agent. The artifact list encrypted with the public key of the site vulnerability service may be published on the artifact dependency publish service via a known standards-based web services access protocol, e.g., representational state transfer (REST), simple object access protocol (SOAP), GOOGLE remote procedure calls (gRPC), etc., which may be exposed by the artifact dependency publish service. The artifact dependency publish agent may call the API of the artifact dependency publish service and publish the encrypted artifact list. Along with the encrypted artifact list, an associated hash may additionally and/or alternatively be posted, e.g., to the site vulnerability service, as a signature.

In some approaches, a site vulnerability service may be used to declare whether any application hosted at any domain is vulnerable or not. The site vulnerability service may be caused to maintain a public key infrastructure and share its domain specific public key to domains that procure its service. The artifact publish agents may be caused to use the domain specific public key of site vulnerability service to encrypt the artifact list before publishing the artifact list to the artifact publish service. Any predetermined type of key management service (KMS) may be leveraged to be caused to generate and perform key lifecycle management.

The list of artifacts may be caused to be fetched, e.g., by the site vulnerability service, and used by the application hosted at the domain. In some approaches, the site vulnerability service may use the artifact dependency publish service to fetch the list of artifacts used by the application hosted at a domain. After fetching the list, which is preferably in the encrypted form, the list may be decrypted using the domain specific private key, e.g., by the site vulnerability service. For each artifact used by the application, the list of vulnerabilities found in that artifact and version may be fetched, e.g., by the site vulnerability service. This information is available in the artifact vulnerability directory. These decrypted artifacts may establish the results obtained based on the agent scanning at least some components of the infrastructure, which may, in some approaches, be compared with predetermined tolerance thresholds to determine the relative extents of vulnerabilities. In some other approaches, the relative extents of vulnerabilities may additionally and/or alternatively include the artifacts, e.g., the decrypted artifacts and/or the encrypted artifacts.

In some approaches, the result of the vulnerability analysis may be stored, e.g., by the site vulnerability service, in a predetermined format, e.g., which may be hereafter referred to as the continuous vulnerability compliance (CVC) format. An illustrative example of this format may include:
<artifact-id>:
<comma separated list of vulnerability ids found in the artifact>:
<date of scan>:
<vulnerability status i.e., secure/vulnerable>

Results of performing the scans may, in some approaches, be converted, e.g., optionally by the site vulnerability service, to other or more other formats. For example, in some approaches, the results of the scans may be converted to a CVC format described elsewhere above. It may be checked whether any vulnerability is present in any of the artifacts published for a domain. More specifically, in some approaches, the site vulnerability service may perform the check to determine whether any vulnerability is present in any of the artifacts published for a domain in the artifact dependency publish service. In response to a determination that a vulnerability is present in any artifact present in the artifact list, e.g., the list fetched from the artifact dependency publish service, for that domain, then the site and/or domain may be determined to be, e.g., considered, declared, flagged, etc., as relatively vulnerable.

Operation 210 includes storing the determined relative extents of vulnerabilities associated with the web applications deployed on the domains in a predetermined table. For example, the predetermined table may be a table stored on a memory module used by the vulnerability service. The determined relative extents of vulnerability may be ongoingly updated, and thereafter the table may be updated.

The determined relative extents of vulnerabilities may be used to forewarn users using a user device to access one of the domains, a real-time status of whether components associated with the web applications deployed on the domain are vulnerable, e.g., based on such vulnerabilities being present or absent on such components. For example, operation 212 includes outputting, publishing for display on the user device, a depiction of the relative extent of vulnerability associated with the web applications deployed on a first of the domains in response to a determination that a user device is attempting to access the first domain. In some approaches, the determination that the user device is attempting to access the first domain may be based on a received request that is made by the user device to a uniform resource locator (URL) of the first domain. In response to receiving the request, in some approaches, method 200 optionally includes querying the vulnerability service to determine the depiction of the relative extent of vulnerability associated with the web applications deployed on the first domain, which may be based on information stored in a table. The determined depiction may then be output for display on the user device.

The depiction of the relative extents of vulnerabilities, in some approaches, includes a graphical icon for display on a predetermined portion of a browser used to access the first domain. The graphical icon that is output for display on the predetermined portion of the browser may depend on whether the web applications deployed on the first domain are determined to be associated with vulnerability or not. For example, in some approaches, a first representation of the graphical icon may be output for display on the user device in response to a determination that the relative extent of vulnerability associated with the web applications deployed on the first domain does not exceed a predetermined threshold. The first representation may indicate, e.g., a check mark, a smiley face, a company logo, any predetermined icon, etc., that the infrastructure components associated with and/or used by the web applications deployed on the first domain have been checked and are determined to not contain vulnerabilities. In contrast, a second representation of the graphical icon may be output for display on the user device in response to a determination that the relative extent of vulnerability associated with the web applications deployed on the first domain exceeds a predetermined threshold. The first representation may indicate, e.g., a stricken first graphical icon, a frown face, a company logo with an “X” over the logo, a predetermined icon with an “X” over the predetermined icon, a warning sign, a flag, etc., that the infrastructure components associated with and/or used by the web applications deployed on the first domain have been checked and determined to contain vulnerabilities. In some approaches in which the techniques, e.g., scans, described herein have not been performed for a domain that is being accessed, method 200 optionally includes not outputting a representation of the graphical icon to indicate that the web application has not been ensured to interact with infrastructure components that have been ensured to be not vulnerable, e.g., secure. In an alternative approach, assuming that the techniques, e.g., scans, described herein have not been performed for a domain that is being accessed, method 200 optionally includes outputting a predetermined third representation of the graphical icon to indicate that the web application has not been ensured to interact with infrastructure components that have been ensured to be not vulnerable, e.g., secure.

The depiction of the relative extents of vulnerabilities is, in some other approaches, textual information, e.g., for displaying in a command line and/or text terminal. Note that such textual information may, in some approaches, be output for display on the user device in response to receiving an indication of selection, e.g., a cursor selection, on the graphical icon displayed on the predetermined portion of the browser used to access the first domain. In some approaches, the depiction of the relative extents of vulnerabilities is the artifact format described elsewhere above, e.g., see the CVC format. Details, e.g., information, of the textual information may include any, one or more of, e.g., total counts of vulnerabilities, a severity of a vulnerability, a date of a scan performed by the agent on components of the infrastructure, a date of first occurrence of a vulnerability, and a date of remediation of a vulnerability, etc. In some approaches, the textual information may include extension information, e.g., such as V3 extensions, which may be based on an extension such as KeyUsage by IBM. A non-exhaustive list of such extension information may, in some approaches, include a digital signature, a non-repudiation, a key encipherment, a data encipherment, a key agreement, a key usage, e.g., such as keyCertSign, cRLSign, encipher only, decipher only, etc. The textual information may include different relative extents of vulnerabilities associated with the web applications deployed on the first domain for displaying in the command line and/or text terminal. For example, the textual information may be defined and based on what types of vulnerability and/or a number of vulnerabilities that are determined to be associated with the web applications deployed on the domains. The textual information that is output to the user device may also be based on a user credential previously entered on the user device. For example, in response to a determination that the credentials of an administrator of the first domain and/or associated web applications were most recently entered into the user device, the output textual information may include all the known details for the vulnerabilities determined to be associated with the web applications deployed on the first domain. In contrast, in response to a determination that the credentials of a customer and/or an employee with a relatively lower degree of access credentials than the administrator was most recently entered into the user device, the output textual information may include a predetermined portion of the known details for the vulnerabilities determined to be associated with the web applications deployed on the first domain. In some approaches, the textual information may rank the vulnerabilities with respect to one another based on predetermined ranking parameters.

In some approaches, an artificial intelligence (AI) model may be trained and configured to perform the analysis and determinations described herein, e.g., see method 200. In some approaches, the AI model may be trained using a predetermined set of training data to train the AI model.

It should be noted that, although various approaches described herein are described from the perspective of the first domain, because relative extents of vulnerability are preferably determined for each of the registered domains, one or more of the operations described herein may additionally and/or alternatively be performed with respect to the one or more of the other domains, e.g., in response to a determination that the user device is attempting to access a second domain, in response to a determination that the user device is attempting to access a third domain, etc.

Numerous benefits are enabled as a result of the techniques of various embodiments and approaches described herein. This is because depicting a relative extent of vulnerability associated with a web application deployed on a domain has heretofore not been considered in conventional applications. This is because currently, there is no way for a client and/or user to confirm that there is no vulnerability present in an infrastructure they are interacting with. It should be noted that conventional certificates being presented by a server to a user to confirm that the server is in fact who the server is claiming to be does not ensure that a vulnerability is not present in the server. For example, such certificates to not address the problem of knowing whether vulnerable components exist in the infrastructure. Furthermore, conventional vulnerability measures fail to make a user aware of the vulnerability status of an application behind the domain the user is interacting with. Accordingly, currently, there is no way for end users to know whether they are interacting with an application that has vulnerabilities which can endanger the user's data being transmitted through and/or stored in the application, which is behind the domain. In sharp contrast to the deficiencies of the conventional techniques described above, using various of the novel techniques described herein, upon connecting to a domain, users obtain the continuous vulnerability service/authority name which is procured/used by the domain owner to provide a real time vulnerability status of an application deployed on the domain via a continuous vulnerability service/authority. This way, users are informed whether there is vulnerability present in an infrastructure that they are interacting with, e.g., the user's data is passing through and/or stored on. This confirms that the client's and/or user's data and transactions occurring in or through that infrastructure will remain secure, which ultimately reduces an amount of processing that is performed on a computer device because vulnerability recovery operations do not have to be performed. Accordingly, the inventive discoveries disclosed herein with regards to use of depicting a relative extent of vulnerability associated with a web application deployed on a domain proceed contrary to conventional wisdom.

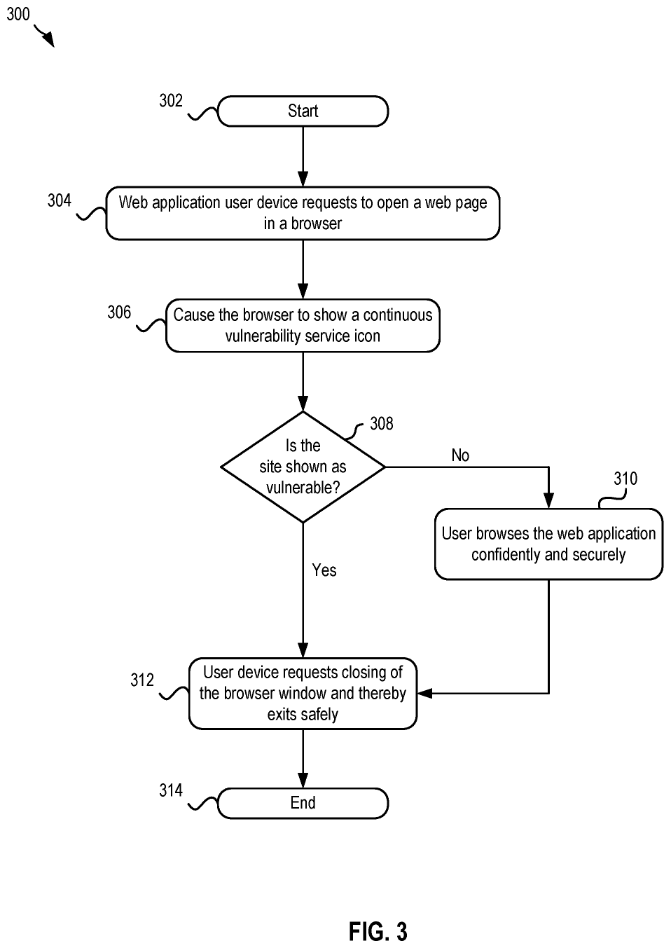

Now referring to FIG. 3, a flowchart of a method 300 is shown according to one embodiment. The method 300 may be performed in accordance with the present invention in any of the environments depicted in FIGS. 1-6C, among others, in various embodiments. Of course, more or fewer operations than those specifically described in FIG. 3 may be included in method 300, as would be understood by one of skill in the art upon reading the present descriptions.

Each of the steps of the method 300 may be performed by any suitable component of the operating environment. For example, in various embodiments, the method 300 may be partially or entirely performed by a processing circuit, or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 300 illustrates a flowchart of a continuous vulnerability compliance user experience, e.g., that a user of a user device experiences as a result of the techniques of various embodiments and/or approaches described herein.

In operation 302 the experience starts, e.g., the user may turn on and/or use a user device, e.g., a web application user device such as a computer. In operation 304, the web application user device requests to open a web page in a browser. In some approaches, this request may be initiated by entering an address of a domain in an address search bar. In some approaches, upon receiving such a request by the user device to a URL of the domain, the vulnerability status of each domain of the URL connected by the web browser/client may, in real time, query the continuous vulnerability service, referred by the domain, if any, via a web API. The browser may be caused to show a continuous vulnerability service icon, e.g., see operation 306. In other words, in one approach, a graphical icon that is a depiction of a relative extent of vulnerability associated with web applications deployed on the requested domain is output in response to a determination that the user device is attempting to access the domain. The graphical icon may show the site as vulnerable, e.g., see “Yes” logical path of decision 308, or show the site as not vulnerable, e.g., see “No” logical path of decision 308. Assuming that domain, e.g., “site,” is not vulnerable, the user may browse the web application confidently and securely, e.g., see operation 310, knowing that infrastructure components associated with the web application are not subjected to vulnerability. In contrast, assuming that domain, e.g., “site,” is vulnerable, the user is warned of the vulnerability before optionally electing to use the web applications. In another approach, based on being warned of the vulnerability, the user device may request closing of the browser window and thereby exits safely, e.g., see operation 312. In operation 314, the user experience optionally ends based on the browser being closed.

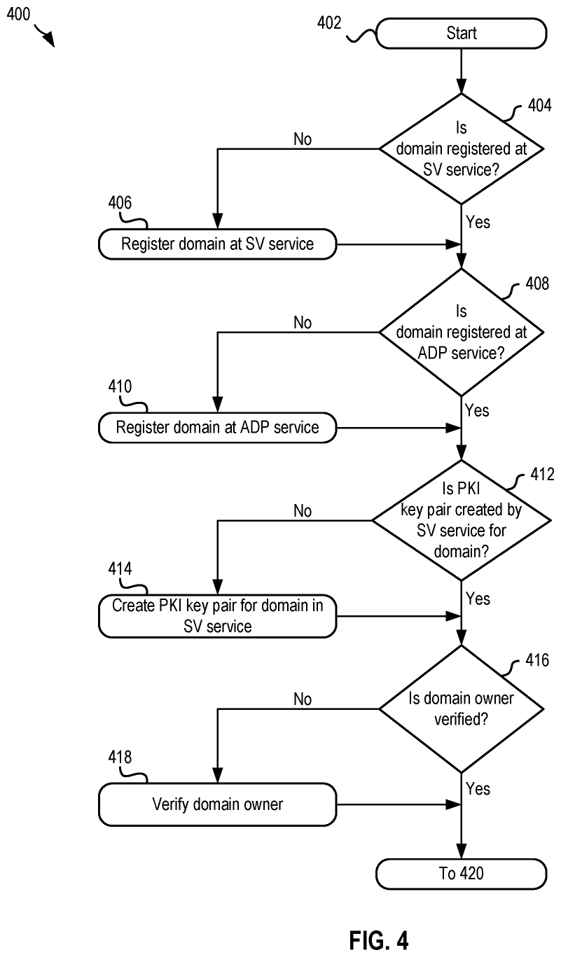

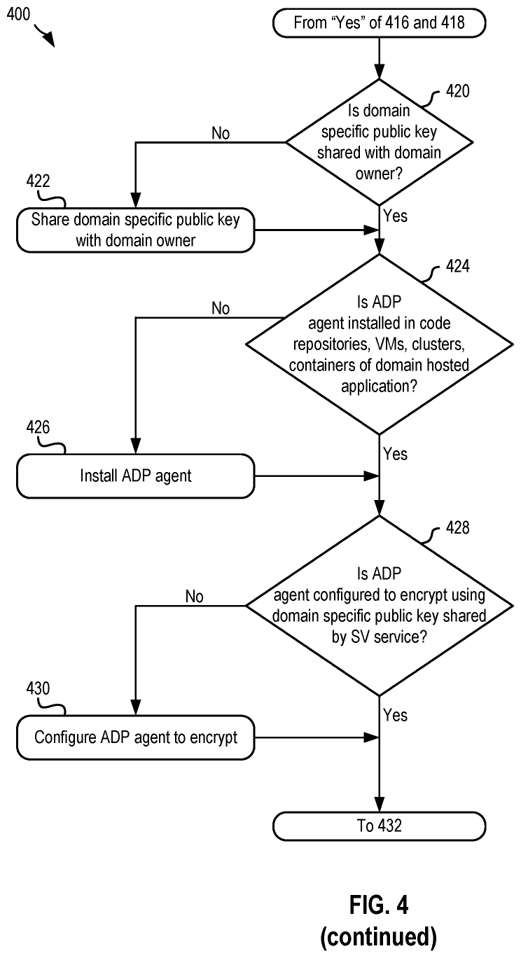

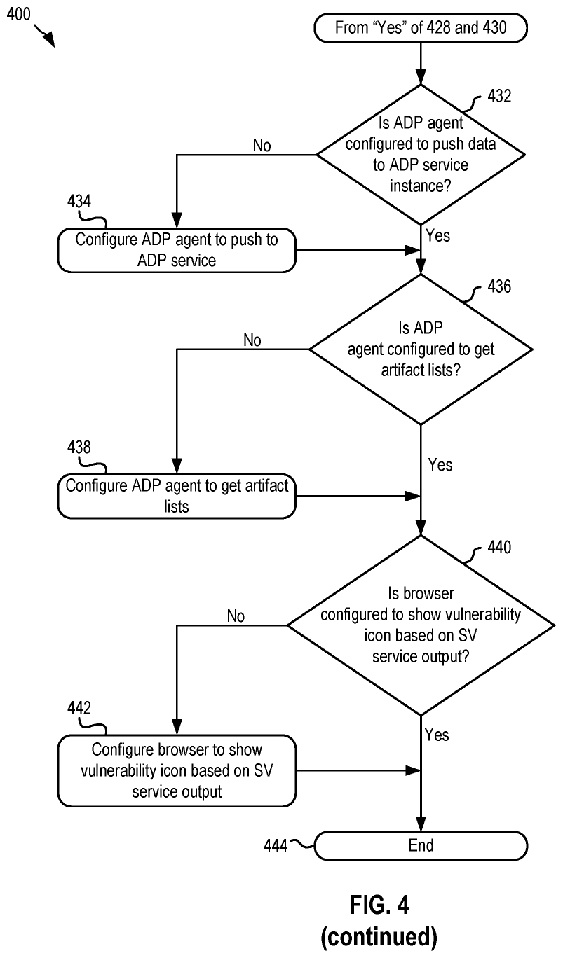

Now referring to FIG. 4, a flowchart of a method 400 is shown according to one embodiment. The method 400 may be performed in accordance with the present invention in any of the environments depicted in FIGS. 1-6C, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a processing circuit, or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that the flowchart of method 400 illustrates a continuous vulnerability compliance backend. In other words, the flowchart of method 400 includes a plurality of backend determination and backend operations which may optionally be performed to configure and/or maintain the continuous vulnerability techniques described herein.

Operation 402 initializes the flowchart in some approaches, although, it should be noted that the flowchart may be initiated at any operation, depending on the approach. One or more operations may be performed in order to register domains to be connected with a vulnerability service, e.g., see operation 206 described elsewhere herein. Decision 404 includes determining whether a domain is registered at a vulnerability service, e.g., SV service. A registry of the service may, in some approaches, be checked to make such a determination. In response to a determination that the domain is not registered at the vulnerability service, the domain is registered, e.g., see operation 406.

Decision 408 incudes determining whether the domain is registered at an artifact dependency publish service, e.g., see ADP service. In response to a determination that the domain is not registered at the artifact dependency publish service, the domain is registered, e.g., see operation 410. Decision 412 includes determining whether a public key infrastructure (PKI) key pair has been created by the vulnerability for the domain, and in response to a determination that such a key pair has not been created, a PKI key pair is created for the domain in the vulnerability service, e.g., see operation 414.

Verification of the domain owner may additionally and/or alternatively be determined, e.g., see decision 416. In response to a determination that the domain owner is not verified, the domain owner may be verified, e.g., see operation 418, using a process that would become apparent to one of ordinary skill in the art upon reading descriptions herein. It is also determined whether a domain specific public key is shared with the domain owner, e.g., see decision 420, and it may be shared, e.g., see operation 422, in response to a determination that the domain specific public key is not shared.

One or more operations may additionally and/or alternatively be performed in method 400 to configure an agent of the vulnerability service that the domain is registered to be connected to. For example, decision 424 includes determining whether an ADP agent is installed in, e.g., code repositories, VMs, clusters, containers of domain hosted application, etc. In response to a determination that such an agent is not installed, the agent is caused to be installed, e.g., see operation 426. It may furthermore be determined whether the ADP agent is configured to encrypt using a domain specific public key shared by the vulnerability service, e.g., see decision 428. In response to a determination that the ADP agent is not configured in such a way, the ADP agent is configured to perform such encryption, e.g., see operation 430.

Decision 432 incudes determining whether the ADP agent is configured to push data to an ADP service instance. The agent is caused to be configured to push such data in response to a determination that the agent is not already configured to do so, e.g., see operation 434. In some approaches, the agent is configured to perform scans and thereafter push information including scan results. For example, it may be determined whether the ADP agent is configured to get artifacts lists, e.g., see decision 436. The ADP agent may be configured to get the artifact lists in response to a determination that the ADP agent is not already configured to do so, e.g., see operation 438.

One or more operations may additionally and/or alternatively be performed to ensure that a browser is configured to display a vulnerability icon. For example, it may be determined whether a browser is configured to show a vulnerability icon based on a vulnerability service output and/or a determination of a relative extent of vulnerability, e.g., see decision 440. The browser may be configured to show the icon in response to a determination that the browser is not already configured in such a way, e.g., see operation 442. In operation 444, the method optionally ends.

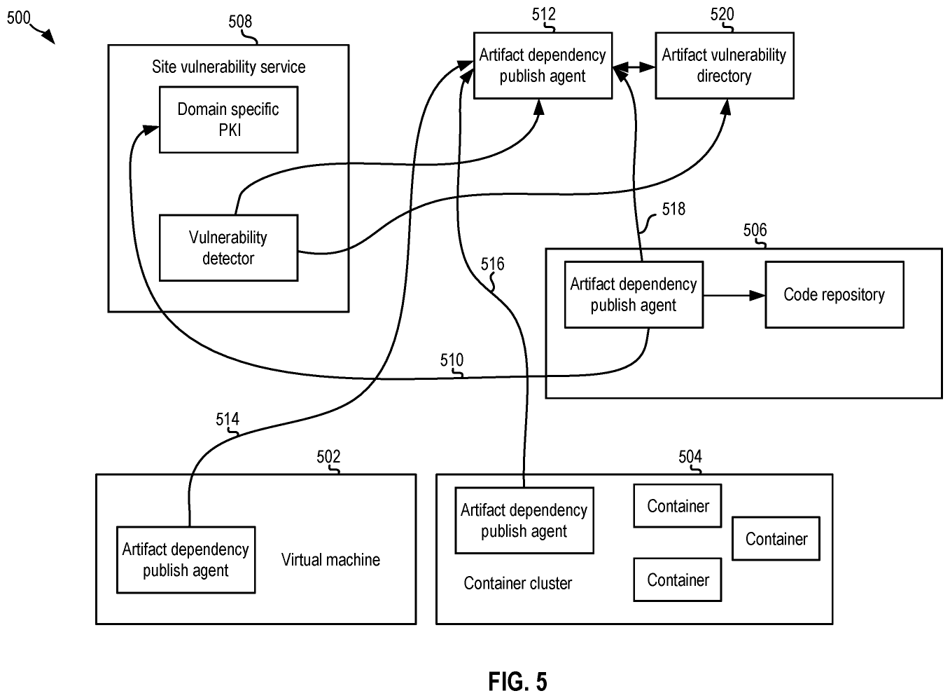

FIG. 5 depicts a system 500, in accordance with one embodiment. As an option, the present system 500 may be implemented in conjunction with features from any other embodiment listed herein, such as those described with reference to the other FIGS. Of course, however, such system 500 and others presented herein may be used in various applications and/or in permutations which may or may not be specifically described in the illustrative embodiments listed herein. Further, the system 500 presented herein may be used in any desired environment.

For context, every website may have one or more web applications and other components running behind the portal which serve as the infrastructure components. For example, these infrastructure components may include, e.g., servers, database servers, web servers, physical servers, logical servers, a virtual machine 502, containers of a container cluster 504, code repository 506, etc. A web application may be associated with the infrastructure component, e.g., use such resources to perform one or more predetermined tasks to render the web application of the domain. In some approaches, an agent may be installed by a predetermined continuous compliance authority that owns and maintains a site vulnerability service 508. The agent of the site vulnerability service 508, e.g., see “artifact dependency publish agent,” may be installed on any one or more of: the virtual machine 502, the container cluster 504 and the code repository 506. More specifically, in some approaches, such as in a case of the code repository 506, the agent may be installed at a location that code of the code repository 506 is refreshed and scanned. In some approaches, the agent(s) may use a known type of vulnerability scanning techniques that would become appreciated to one of ordinary skill in the art upon reading the descriptions herein to obtain vulnerability results, e.g., vulnerability information described elsewhere herein, e.g., see operation 208. The results may, in some approaches, be pushed back to the site vulnerability service 508 by the agent, e.g., see operation 510. Furthermore, results of different agents on the virtual machine 502, the container cluster 504 and the code repository 506 may relay the results to a primary artifact dependency publish agent 512, in some approaches, e.g., see operations 514, 516 and 518. This information, e.g., artifacts, may be used to determine relative extents of vulnerabilities associated with the web applications deployed on domains registered with the site vulnerability service 508. In some approaches, unique identifiers of such information may be provided to the primary artifact dependency publish agent 512 by a predetermined directory, e.g., see artifact vulnerability directory 520. The information may include results of scans performed by an agent that indicate vulnerabilities such as, e.g., failures to update software run on one or more components of the infrastructure, outdated versions of software being run on one or more components of the infrastructure, non-compatible software being run on different components of the infrastructure that may cause errors to occur on the web application, different versions of software and/or firmware being run on different components of the infrastructure that may cause errors to occur on the web application, latency issues being experienced by one or more components of the infrastructure, physical component failures being experienced by one or more components of the infrastructure, one or more software versions being run on components of the infrastructure that are predetermined to be vulnerable, etc.

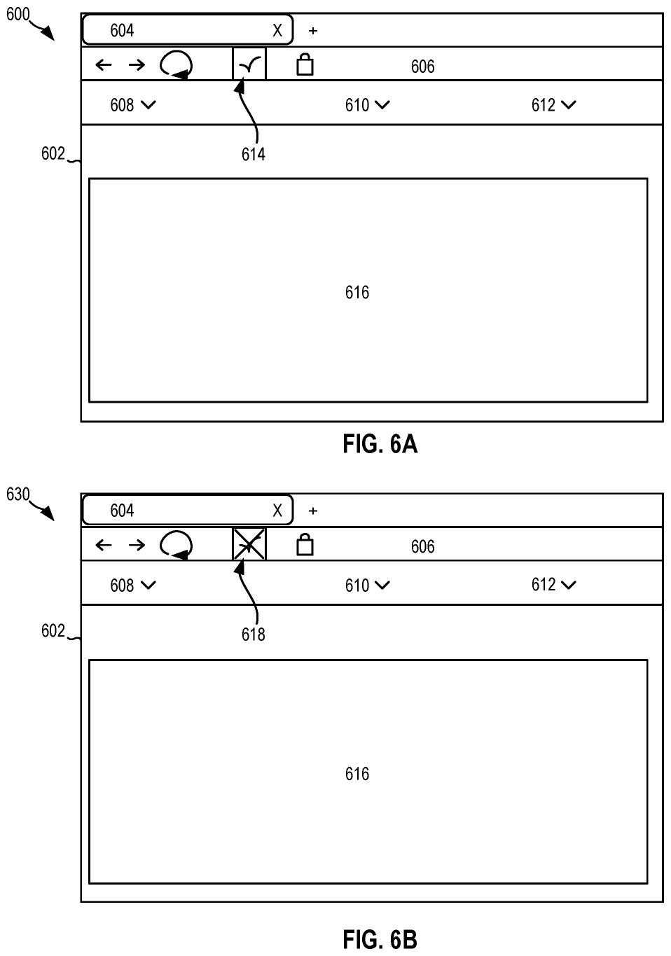

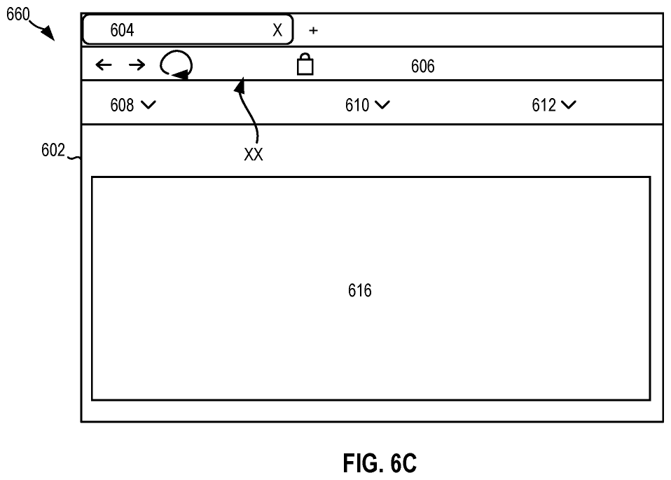

A depiction of the relative extent of vulnerability associated with the web applications deployed on a first of the domains may be output for display on a user device in response to a determination that the user device is attempting to access the first domain. Examples of such depictions are described in further detail elsewhere herein, e.g., see FIGS. 6A-6C.

FIGS. 6A-6C depict representations 600, 630 and 660 of a user interface of a web browser 602, in accordance with several embodiments. As an option, the present representations 600, 630 and 660 may be implemented in conjunction with features from any other embodiment listed herein, such as those described with reference to the other FIGS. Of course, however, such representations 600, 630 and 660 and others presented herein may be used in various applications and/or in permutations which may or may not be specifically described in the illustrative embodiments listed herein. Further, the representations 600, 630 and 660 presented herein may be used in any desired environment.

The representations of FIGS. 6A-6C categorize and display different levels of vulnerabilities, e.g., as a vulnerability status, of for a domain of a URL connected by a web browser/client.

Referring first to representation 600 of FIG. 6A, the web browser 602 includes a tab 604, a domain address 606, and dropdown tabs 608, 610 and 612 offered by the web browser 602, and contents 616 of web applications deployed on a domain defined by the domain address 606.

A depiction of a relative extent of vulnerability associated with the web applications deployed on the domain defined by the domain address 606 is displayed on a user device in response to a determination that the user device is attempting to access the domain. More specifically, the depiction is a first graphical icon 614, which includes a check mark to indicate that the extent of vulnerability associated with the web applications deployed on the domain is acceptable, e.g., within a predetermined range of acceptable vulnerability.

In contrast, referring now to representation 630 of FIG. 6B, the web browser 602 includes a second graphical icon 618, which includes a crossed-out check mark to indicate that the extent of vulnerability associated with the web applications deployed on the domain is unacceptable, e.g., outside of the predetermined range of acceptable vulnerability and, and thereby that the user's information is not secure during and/or after using the web applications.

Referring now to representation 660 of FIG. 6C, the web browser 602 does not include a graphical icon. A lack of such a graphical icon being illustrated in the web browser 602 may indicate to a user that the operations described in embodiments and approaches herein have not been performed, and the user thereby is warned to navigate the web browser at their own risk.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
registering domains to be connected with a vulnerability service;
using information obtained by an agent of the vulnerability service from infrastructure associated with web applications deployed on the domains to determine, for each domain, a relative extent of vulnerability associated with the web applications deployed on the domain; and
outputting, for display on a user device, a depiction of the relative extent of vulnerability associated with the web applications deployed on a first of the domains in response to a determination that a user device is attempting to access the first domain.

2. The computer-implemented method of claim 1, wherein the depiction includes a graphical icon for display on a predetermined portion of a browser used to access the first domain.

3. The computer-implemented method of claim 2, wherein a first representation of the graphical icon is output for display on the user device in response to a determination that the relative extent of vulnerability associated with the web applications deployed on the first domain does not exceed a predetermined threshold, wherein a second representation of the graphical icon is output for display on the user device in response to a determination that the relative extent of vulnerability associated with the web applications deployed on the first domain exceeds a predetermined threshold.

4. The computer-implemented method of claim 1, wherein the depiction includes textual information for display in a command line and/or text terminal.

5. The computer-implemented method of claim 4, wherein the textual information is selected from the group consisting of: total counts of vulnerabilities, a severity of a vulnerability, a date of a scan performed by the agent on components of the infrastructure, a date of first occurrence of a vulnerability, and a date of remediation of a vulnerability, wherein the textual information includes different relative extents of vulnerabilities associated with the web applications deployed on the first domain for displaying in the command line and/or text terminal.

6. The computer-implemented method of claim 1, wherein the relative extents of vulnerabilities are determined based on results obtained based on the agent scanning at least some components of the infrastructure, wherein using the information obtained by the agent to determine the relative extents of vulnerabilities associated with the web applications deployed on the domains includes: comparing the results with predetermined tolerance thresholds.

7. The computer-implemented method of claim 6, wherein the results are selected from the group consisting of: a version of software run by at least one server of the infrastructure, hardware of at least some of the infrastructure, toolkits used by at least one server of the infrastructure, libraries of the infrastructure, code of a code repository of the infrastructure, and dependencies among different components of the infrastructure.

8. The computer-implemented method of claim 7, wherein the components are selected from the group consisting of: a virtual machine, a container, a code repository, physical hardware, and software.

9. The computer-implemented method of claim 1, comprising: storing the determined relative extents of vulnerabilities in a predetermined table, wherein the determination that the user device is attempting to access the first domain is based on a received request that is made by the user device to a uniform resource locator (URL) of the first domain; and querying the vulnerability service to determine the depiction of the relative extent of vulnerability associated with the web applications deployed on the first domain.

10. The computer-implemented method of claim 1, comprising: validating the vulnerability service; and outputting, to a client device, connection parameters of the vulnerability service in response to the vulnerability service being validated.

11. A computer program product, the computer program product comprising a computer readable storage medium having program instructions embodied therewith, the program instructions readable and/or executable by a processing circuit to cause the processing circuit to:
register, by the processing circuit, domains to be connected with a vulnerability service;
use, by the processing circuit, information obtained by an agent of the vulnerability service from infrastructure associated with web applications deployed on the domains to determine, for each domain, a relative extent of vulnerability associated with the web applications deployed on the domain;
receive, by the processing circuit, a request from a user device to access a first of the domains; and
output, by the processing circuit, for display on a user device, a depiction of the relative extent of vulnerability associated with the web applications deployed on a first of the domains in response to a determination that a user device is attempting to access the first domain.

12. The computer program product of claim 11, wherein the depiction includes a graphical icon for display on a predetermined portion of a browser used to access the first domain.

13. The computer program product of claim 12, wherein a first representation of the graphical icon is output for display on the user device in response to a determination that the relative extent of vulnerability associated with the web applications deployed on the first domain does not exceed a predetermined threshold, wherein a second representation of the graphical icon is output for display on the user device in response to a determination that the relative extent of vulnerability associated with the web applications deployed on the first domain exceeds a predetermined threshold.

14. The computer program product of claim 11, wherein the depiction includes textual information for display in a command line and/or text terminal.

15. The computer program product of claim 14, wherein the textual information is selected from the group consisting of: total counts of vulnerabilities, a severity of a vulnerability, a date of a scan performed by the agent on components of the infrastructure, a date of first occurrence of a vulnerability, and a date of remediation of a vulnerability, wherein the textual information includes different relative extents of vulnerabilities associated with the web applications deployed on the first domain for displaying in the command line and/or text terminal.

16. The computer program product of claim 11, wherein the relative extents of vulnerabilities are determined based on results obtained based on the agent scanning at least some components of the infrastructure, wherein using the information obtained by the agent to determine the relative extents of vulnerabilities associated with the web applications deployed on the domains includes: comparing the results with predetermined tolerance thresholds.

17. The computer program product of claim 16, wherein the results are selected from the group consisting of: a version of software run by at least one server of the infrastructure, hardware of at least some of the infrastructure, toolkits used by at least one server of the infrastructure, libraries of the infrastructure, code of a code repository of the infrastructure, and dependencies among different components of the infrastructure.

18. The computer program product of claim 11, the program instructions readable and/or executable by the processing circuit to cause the processing circuit to: store, by the processing circuit, the determined relative extents of vulnerabilities in a predetermined table, wherein the determination that the user device is attempting to access the first domain is based on a received request that is made by the user device to a uniform resource locator (URL) of the first domain; and querying the vulnerability service to determine the depiction of the relative extent of vulnerability associated with the web applications deployed on the first domain.

19. The computer program product of claim 11, the program instructions readable and/or executable by the processing circuit to cause the processing circuit to: validate, by the processing circuit, the vulnerability service; and output, by the processing circuit, to a client device, connection parameters of the vulnerability service in response to the vulnerability service being validated.

20. A system, comprising:
a processor; and
logic integrated with the processor, executable by the processor, or integrated with and executable by the processor, the logic being configured to:
register domains to be connected with a vulnerability service;
use information obtained by an agent of the vulnerability service from infrastructure associated with web applications deployed on the domains to determine, for each domain, a relative extent of vulnerability associated with the web applications deployed on the domain; and
output, for display on a user device, a depiction of the relative extent of vulnerability associated with the web applications deployed on a first of the domains in response to a determination that a user device is attempting to access the first domain.
